(19) United States
(12) Patent Application Publication
(10) Pub. No.: US 2026/0233972 A1
(43) Pub. Date: Aug. 13, 2026

(54) TENSION DEVICE FOR ELEVATOR CAR, ELEVATOR CAR AND ELEVATOR SYSTEM

(71) Applicant: Otis Elevator Company, Farmington, CT (US)

(72) Inventor: Bing Li, Shanghai (CN)

(21) Appl. No.: 19/402,365

(22) Filed: Nov. 26, 2025

(30) Foreign Application Priority Data
Feb. 7, 2025 (CN) 202510138138.6

(51) Int. Cl. B66B 7/06

(52) U.S. Cl. CPC B66B 7/06

(57) ABSTRACT

A tension device for an elevator car, an elevator car, and an elevator system. The elevator car has a first side portion and a second side portion opposite to each other and a rear side portion opposite to a car door, and an elevator counterweight is arranged on a side close to the first side portion, the tension device includes a tension member, and a first end and a second end of the tension member are fixed to a first position and a second position on the elevator car respectively, to provide a first tensile force acting on the elevator car, and the first tensile force is substantially parallel to a longitudinal direction of the elevator car at the top of the elevator car and directed towards the rear side portion.

### FOREIGN PRIORITY

This application claims priority to Chinese Patent Application No. 202510138138.6, filed Feb. 7, 2025, and all the benefits accruing therefrom under 35 U.S.C. § 119, the contents of which in its entirety are herein incorporated by reference.

### TECHNICAL FIELD OF INVENTION

The present disclosure relates to the technical field of elevators, and in particular, to a tension device for an elevator car, an elevator car, and an elevator system.

### BACKGROUND OF THE INVENTION

Various types of elevator equipment have been installed in many places and environments to transport people, goods, etc. to the target floors, which can bring great convenience to people's work, life, and travel. Elevator equipment is generally configured with an elevator car and a counterweight, which are connected by means of, for example, hoist ropes, etc., so that during the ascending and descending process of the elevator car, the counterweight can be used to balance the load and ensure the safe and smooth operation of the elevator. When installing an elevator system, the counterweight is mostly arranged at the rear side of the elevator car, that is, the rear-mounted counterweight layout scheme is adopted. In some application scenarios, such as home lifts with relatively limited space, the counterweight can also be arranged on the left or right side of the elevator car, that is, the side-mounted counterweight layout scheme is adopted.

### SUMMARY OF THE INVENTION

In view of the foregoing, the present disclosure provides a tension device for an elevator car, an elevator car, and an elevator system, so as to solve or at least alleviate one or more of the problems existing in the prior art and other problems in other aspects, or to provide alternative technical solutions for the prior art.

Firstly, according to one aspect of the present disclosure, a tension device for an elevator car is provided. The elevator car has a first side portion and a second side portion opposite to each other and a rear side portion opposite to a car door, and an elevator counterweight is arranged on a side close to the first side portion, the tension device comprises a tension member, and a first end and a second end of the tension member are fixed to a first position and a second position on the elevator car respectively, to provide a first tensile force acting on the elevator car, and the first tensile force is substantially parallel to a longitudinal direction of the elevator car at the top of the elevator car and directed towards the rear side portion.

In a tension device for an elevator car according to the present disclosure, optionally, the tension member is arranged close to the second side portion, and the first position and the second position are disposed at the top and bottom of the elevator car respectively.

In a tension device for an elevator car according to the present disclosure, optionally, the first position is disposed on a door lintel at the top of the elevator car, and the second position is disposed on a bottom frame of the elevator car.

In a tension device for an elevator car according to the present disclosure, optionally, the tension member includes a steel wire rope.

In a tension device for an elevator car according to the present disclosure, optionally, the tension device further comprises one or more guiding members arranged on an outer surface of the elevator car and located between the first position and the second position, and the tension member is wound around the guiding members to change a movement direction of the tension member.

In a tension device for an elevator car according to the present disclosure, optionally, the guiding members comprise a first guiding member and a second guiding member, and the first guiding member is arranged at the top or on the rear side portion of the elevator car and the second guiding member is arranged at the bottom or on the rear side portion of the elevator car, such that the tension member is spaced a preset distance from the outer surface of the elevator car.

In a tension device for an elevator car according to the present disclosure, optionally, the tension member is arranged such that a portion located between the first guiding member and the second guiding member is substantially parallel to a vertical direction of the elevator car.

In a tension device for an elevator car according to the present disclosure, optionally, the guiding member includes a roller.

In a tension device for an elevator car according to the present disclosure, optionally, the tension device further comprises a tension adjustment member connected to the tension member and configured to adjust magnitude of the first tensile force.

In a tension device for an elevator car according to the present disclosure, optionally, the tension adjustment member is arranged at the bottom of the elevator car and connected to the second end of the tension member.

In a tension device for an elevator car according to the present disclosure, optionally, the tension device further comprises a tensile member, and a first end of the tensile member is fixed at a third position on the elevator car and a second end of the tensile member is connected to a column located on the side where the first side portion is located and connected to a bottom frame of the elevator car, to provide a second tensile force acting on the elevator car, the second tensile force being non-parallel to the longitudinal direction of the elevator car.

In a tension device for an elevator car according to the present disclosure, optionally, the third position coincides with or is adjacent to the first position.

Secondly, according to another aspect of the present disclosure, an elevator car comprising a tension device for an elevator car according to any of the above is also provided.

In addition, according to yet another aspect of the present disclosure, an elevator system is further provided, which comprises:
an elevator car, comprising a tension device for an elevator car according to any of the above; and
an elevator counterweight, arranged on a side close to the first side portion of the elevator car.

The solutions according to the present disclosure can effectively solve the problem of the elevator car leaning forward towards the landing door in an elevator system with side-mounted counterweight, thereby enhancing the safety performance of the system, saving space, and improving the smoothness of elevator car operation. The tension device for an elevator car according to the present disclosure has the advantages of strong practicality, easy installation, small space occupation and low cost, and can be widely used in many places such as public elevators, home lifts, and the like.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system.

FIG. 2 is a partial three-dimensional structural schematic diagram of an embodiment of an elevator car according to the present disclosure, in which an embodiment of a tension device for an elevator car according to the present disclosure is configured.

FIG. 3 is a partial three-dimensional structural schematic diagram of another embodiment of an elevator car according to the present disclosure, in which another embodiment of a tension device for an elevator car according to the present disclosure is configured.

### DETAILED DESCRIPTION OF THE INVENTION

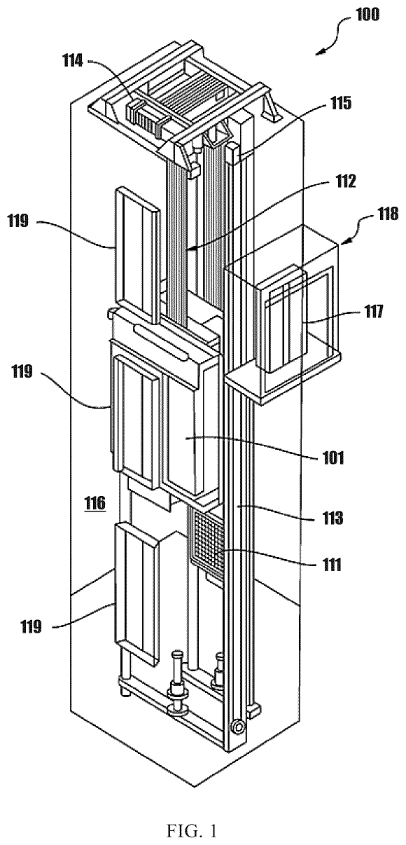

FIG. 1 is a perspective view of an elevator system 100 including an elevator car 101, a counterweight 111, a tension component 112, a guide rail (or rail system) 113, a machine (or machine system) 114, a position reference device 115, and an electronic elevator controller (controller) 117. The elevator car 101 and counterweight 111 are connected to each other by the tension component 112, and travel along the elevator hoistway 116 under the action of driving force. The tension component 112 may include, for example, steel belts (such as coated-steel belts) and/or ropes (such as steel cables). The counterweight 111 is configured to balance a load of the elevator car 101 and is configured to facilitate movement of the elevator car 101 concurrently and in an opposite direction with respect to the counterweight 111 within an elevator hoistway 116 and along the guide rail 113. It should be noted that according to the requirements of different application scenarios, the counterweight 111 can be arranged at the rear or on a side of the elevator car 101, such as on the left or right side of the elevator car 101. FIG. 1 only illustrates the scenario of one example of arranging the counterweight 111 at the rear of the elevator car 101.

The tension component 112 engages the machine 114. The machine 114 is configured to control movement between the elevator car 101 and the counterweight 111. Machine 114 may include a motor or similar power unit to provide driving force to elevator system 100, which may adopt a machine-room-less configuration. The position reference device 115 may be arranged in other positions and/or configurations known in the art, such as being mounted on a fixed part at the top of the elevator hoistway 116. The position reference device 115 may be configured to provide position signals related to a position of the elevator car and/or counterweight within the elevator hoistway. The position reference device 115 can employ any device or mechanism for monitoring a position of an elevator car and/or counterweight, as known in the art. For example, it includes but is not limited to an encoder, a sensor, or other component, and may include speed sensing, absolute position sensing, and the like.

The controller 117 may be located in a controller room 118 of the elevator hoistway 116 and may be configured to control the operation of the elevator system 100, and particularly the elevator car 101. For example, the controller 117 may provide drive signals to the machine 114 to control the acceleration, deceleration, leveling, stopping, etc. of the elevator car 101. The controller 117 may also be configured to receive position signals from the position reference device 115 or any other desired device or system of this kind. When moving up or down within the elevator hoistway 116 along guide rail 113, the elevator car 101 may stop at one or more landings 119 as controlled by the controller 117. Although shown in a controller room 118, those skilled in the art will appreciate that the controller 117 can be located and/or configured in other locations or positions within the elevator system 100, such as located remotely or in the cloud.

Specific elevator systems and components are shown and described herein. Unless otherwise specified, for example, all other configurations except for the rear-mounted counterweight in the example of FIG. 1 can be used for elevator systems and cars thereof configured with side-mounted counterweights, and the tension device according to the present disclosure can be configured for the elevator cars, such as in environments with relatively small elevator hoistway space dimensions, such as home lifts and other occasions. For the sake of simplification of the drawing, identical or similar components and features may only be denoted in one or several places in the same drawing. Technical terms such as “first”, “second”, “third” are only used for distinguishing purposes and are not intended to indicate their order and relative importance. The technical term “connect” includes both direct and indirect connections.

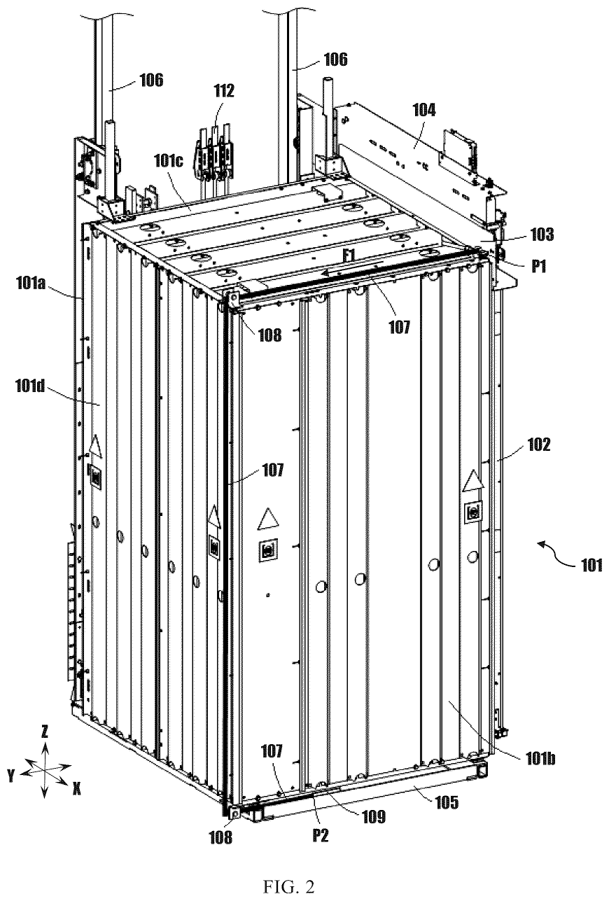

Referring first to FIG. 2, a specific scenario of mounting an embodiment of a tension device onto an elevator car is schematically illustrated. As shown in FIG. 2, the elevator car 101 has a first side portion 101a and a second side portion 101b, which are located on the right and left sides of the car door 102, respectively. As an example, the counterweight 111 can be arranged on the right side of the car door 102, that is, on the side close to the first side portion 101a. FIG. 2 schematically illustrates the tension component 112 arranged on the right side of the elevator car 101, where the elevator car 101 can be connected to the counterweight 111 through the tension component 112.

The embodiment of the tension device shown in FIG. 2 is configured with a tension member 107, guiding members 108, and a tension adjustment member 109. Specifically, the tension member 107 can be in any suitable form such as a steel wire rope, and its specific length, shape, construction, and whether a single tension member or multiple tension members are used can be configured as needed. By respectively fixing the first and second ends of the tension member 107 to a first position P1 and a second position P2 on the elevator car 101, a first tensile force may be provided to act on the elevator car 101. Specifically, the first tensile force mentioned above is configured to be substantially parallel to the longitudinal direction Y of the elevator car 101 (i.e., the depth direction of the elevator car 101, which is perpendicular to the transverse direction (i.e., the width direction) X of the elevator car 101) at the top 101c of the elevator car 101, and the direction of action of the first tensile force is towards the rear side portion 101d of the elevator car 101, as schematically indicated by the reference numeral F1 and an arrow in FIG. 2. In this way, with the help of the first tensile force F1, it is possible to effectively overcome or alleviate the problem of the elevator car 101 tilting forward towards the landing door due to the weight of the car door 102 and the door lintel 103 and door opener 104 mounted on the upper part of the car when side-mounted counterweight is employed.

As used herein, the tension member 107 may be arranged close to the second side portion 101b of the elevator car 101, i.e., it may be mounted, for example, at a position close to the edge of the elevator car 101. This is beneficial in avoiding occupying too much space on the car roof, especially the middle area of the car roof, so as not to affect the installation and arrangement of components or devices that may need to be configured for guardrails, maintenance boxes, and other systems that are to be mounted at the top of the car, thereby improving space utilization and enhancing system safety. Of course, in one or some embodiments, the tension member 107 may also be arranged at other suitable positions on the top 101c according to actual requirements, such as in the middle of the car roof.

The first end of the tension member 107 is fixed to the first position P1 on the elevator car 101, where the first position P1 may be optionally set at a suitable position on the top 101c of the elevator car 101, such as on or near the door lintel 103. The second end of the tension member 107 is fixed to the second position P2 on the elevator car 101, where the second position P2 may be optionally set at the bottom of the elevator car 101, such as on the bottom frame 105. With the help of the guiding members 108, the movement direction of the part of the tension member 107 located between the first end and the second end relative to the outer contour of the elevator car 101 may be adjusted, such as forming a 90° turn, etc., which can facilitate the flexible installation and arrangement of the tension member 107, especially facilitating the achievement of a compact and stable structural arrangement.

For example, referring to the scenario illustrated in the example of FIG. 2, two guiding members 108 may be arranged on the outer surface of the elevator car 101. For example, one guiding member thereof may be arranged at the top 101c or rear side portion 101d of the elevator car 101, and the other guiding member may be arranged at the bottom or rear side portion 101d of the elevator car 101. When mounting the tension member 107, it may be sequentially wound around the two guiding members 108 to change the movement direction of the tension member 107. For example, the part of the tension member 107 located between these two guiding members 108 may be guided to be substantially parallel to the vertical direction Z of the elevator car 101. This will help to maintain the first tensile force F1 in a parallel relationship with the longitudinal direction Y at the top 101c of the elevator car 101, and allow the first tensile force F1 to better act on the elevator car 101 to prevent the forward tilting problem.

In addition, the guiding members 108 may also be used to maintain a preset distance between the tension member 107 and the outer surface of the elevator car 101, such as 0.5 cm, 1 cm, 2 cm, 2.5 cm, 3 cm, etc., where the specific spacing distance can be designed as needed. It should be noted that the spacing distances between the tension member 107 and different areas on the elevator car 101 (such as the top, rear side portion, and bottom) may be the same or different from each other. Regarding the specific configuration quantity, arrangement position, structural configuration, and materials used for the guiding members 108, the present disclosure allows for configuration or adjustment according to actual requirements. For example, one, three, or more rollers may be configured as guiding members. For another example, these guiding members can be the same or different from each other.

As used herein, a tension adjustment member 109 may be configured for the tension member 107 so that it can be used to set and adjust the magnitude of the first tensile force F1 when needed, thereby achieving the desired effect. As an example, the tension adjustment member 109 may be a tensioner configured with a spring (such as a tension spring or torsion spring). The tension adjustment member 109 may be mounted and arranged at the bottom of the elevator car 101, such as fixed to the bottom frame 105 of the elevator car 101, and the second end of the tension member 107 is connected to the tension adjustment member 109. In one or some embodiments, the tension adjustment member 109 may be mounted and arranged at any suitable position between the first end and the second end of the tension member 107, thus also achieving the configuration and adjustment operations of the first tensile force F1.

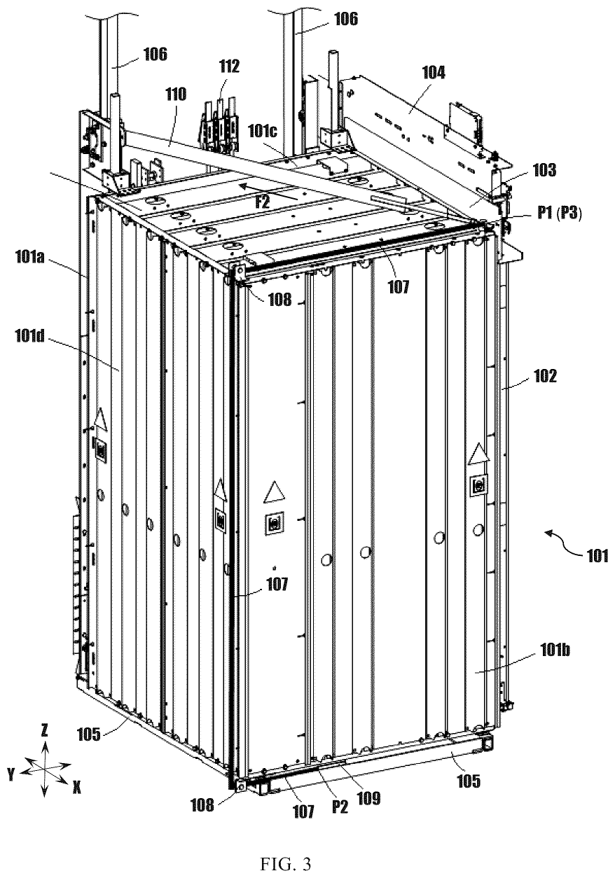

With continued reference to FIG. 3, another embodiment configured according to a tension device of the present disclosure is illustrated. As shown in FIG. 3, in this embodiment, a tension member 107, guiding members 108, a tension adjustment member 109, and a tensile member 110 are provided. The tension member 107, the guiding members 108, and the tension adjustment member 109 have been discussed in detail above, and will not be repeated here.

As shown in FIG. 3, the tensile member 110 may be arranged diagonally at the top 101c of the elevator car 101, which is used to provide a second tensile force on the elevator car 101, as schematically denoted by the reference numeral F2 and an arrow in FIG. 3. The second tensile force F2 does not form a parallel relationship with the longitudinal direction Y of the elevator car 101, that is, the second tensile force F2 is not parallel to the first tensile force F1 mentioned above.

Specifically, the tensile member 110 can adopt any one or more suitable components as needed, such as rigid rods, wire ropes, or combinations thereof. One end of the tensile member 110 may be fixed to the third position P3 on the elevator car 101, where the third position P3 may be selected as needed. For example, it may coincide with or be arranged adjacent to the first position P1. The other end of the tensile member 110 may be connected to a column 106 disposed outside the elevator car 101. In most cases, one or several columns 106 (such as two) may be configured as needed, and they are connected to the bottom frame 105 of the elevator car 101. When two or more columns 106 are configured, the column 106 that is closer to the rear side portion 101d may usually be selected to connect with the tensile member 110.

Although the additional arrangement of the tensile member 110 at the top of the elevator car may occupy some space, in some application scenarios, however, such as when there are no specific requirements for the space of the car roof, the effect of the first tensile force F1 and that of the second tensile force F2 on the elevator car 101 may be used in combination to advantageously avoid or alleviate the forward tilting problem of the elevator car, thereby ensuring more stable and reliable operation of the elevator car, and further improving system safety.

A tension device for an elevator car, an elevator car, and an elevator system according to the present disclosure have been described above in detail by way of examples. It should be noted that these examples are merely used to illustrate the principles and embodiments of the present disclosure, rather than limiting the present disclosure. Various modifications and improvements can be made by those skilled in the art without departing from the scope of the present disclosure. For example, in some embodiments, the guiding members and/or tension adjustment members in the tension device may be removed to simplify the structure and facilitate installation operations. For example, in some embodiments, a portion or the entirety of the tension member may be in direct contact with the outer surface of the elevator car. Therefore, all equivalent technical solutions should fall within the scope of the present disclosure and be limited by the claims of the present disclosure.

What is claimed is:

1. A tension device for an elevator car, the elevator car having a first side portion and a second side portion opposite to each other and a rear side portion opposite to a car door, and an elevator counterweight being arranged on a side close to the first side portion, wherein the tension device comprises a tension member, and a first end and a second end of the tension member are fixed to a first position and a second position on the elevator car respectively, to provide a first tensile force acting on the elevator car, the first tensile force being substantially parallel to a longitudinal direction of the elevator car at the top of the elevator car and directed towards the rear side portion.

2. The tension device for an elevator car according to claim 1, wherein the tension member is arranged close to the second side portion, and the first position and the second position are disposed at the top and bottom of the elevator car respectively.

3. The tension device for an elevator car according to claim 2, wherein the first position is disposed on a door lintel at the top of the elevator car, and the second position is disposed on a bottom frame of the elevator car.

4. The tension device for an elevator car according to claim 1, wherein the tension member includes a steel wire rope.

5. The tension device for an elevator car according to claim 1, wherein the tension device further comprises one or more guiding members arranged on an outer surface of the elevator car and located between the first position and the second position, and the tension member is wound around the guiding members to change a movement direction of the tension member.

6. The tension device for an elevator car according to claim 5, wherein the guiding members comprise a first guiding member and a second guiding member, and the first guiding member is arranged at the top or on the rear side portion of the elevator car and the second guiding member is arranged at the bottom or on the rear side portion of the elevator car, such that the tension member is spaced a preset distance from the outer surface of the elevator car.

7. The tension device for an elevator car according to claim 6, wherein the tension member is arranged such that a portion located between the first guiding member and the second guiding member is substantially parallel to a vertical direction of the elevator car.

8. The tension device for an elevator car according to claim 5, wherein the guiding member includes a roller.

9. The tension device for an elevator car according to claim 1, wherein the tension device further comprises a tension adjustment member connected to the tension member and configured to adjust magnitude of the first tensile force.

10. The tension device for an elevator car according to claim 9, wherein the tension adjustment member is arranged at the bottom of the elevator car and connected to the second end of the tension member.

11. The tension device for an elevator car according to claim 1, wherein the tension device further comprises a tensile member, and a first end of the tensile member is fixed at a third position on the elevator car and a second end of the tensile member is connected to a column located on the side where the first side portion is located and connected to a bottom frame of the elevator car, to provide a second tensile force acting on the elevator car, the second tensile force being non-parallel to the longitudinal direction of the elevator car.

12. The tension device for an elevator car according to claim 11, wherein the third position coincides with or is adjacent to the first position.

13. An elevator car, wherein the elevator car comprises a tension device for an elevator car according to claim 1.

14. An elevator system, comprising:
an elevator car, comprising a tension device for an elevator car according to claim 1; and
an elevator counterweight, arranged on a side close to the first side portion of the elevator car.
